(19) United States
(12) Patent Application Publication
(10) Pub. No.: US 2026/0342810 A1
(43) Pub. Date: Oct. 29, 2026

(54) SYSTEM AND A METHOD OF ALERT MANAGEMENT

(71) Applicant: Honeywell International Inc., Charlotte, NC (US)

(72) Inventors: Adam Engelhart, Bruchin (IL); Rani Fischer, Rehovot (IL); Eli (Alexey) Khitrov, Tel Aviv (IL)

(21) Appl. No.: 19/189,315

(22) Filed: Apr. 25, 2025

(51) Int. Cl. H04L 9/40; G06F 12/0811; G06F 12/127

(52) U.S. Cl. CPC H04L 63/1416; G06F 12/0811; G06F 12/127; H04L 63/1425

(57) ABSTRACT

A method and a system for alert management are disclosed. The system receives and analyzes data traffic from multiple devices in an enterprise to detect anomalies. For each anomaly, an alert configuration (AC) file is identified from a cache memory. If status of the AC file has changed, an updated AC file is obtained from a main memory and replaced in the cache memory. The change in the status of the AC file is monitored and communicated by an operating system component of the system. Further, a decorator function ensures that the AC file is checked for changes before fetching for alert generation. If the AC file is not present in the cache memory, the AC file is retrieved and used from the main memory and stored in the cache memory. Alerts are generated based on parameters in the AC file, including severity levels, activation statuses, and associated actions.

### FIELD OF INVENTION

The present invention generally relates to alert management. More specifically, the present invention is related to alert management using cache memory.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Enterprises such as data centres, industrial plants, and other security-sensitive environments increasingly rely on automated monitoring services to ensure operational integrity, security, and compliance with regulatory standards. Such enterprises generate and process vast amounts of data, including system logs, network traffic, sensor readings, and other telemetry data. The continuous monitoring and analysis of such data are crucial for identifying anomalous events that may indicate security breaches, system failures, or other critical operational issues.

Intrusion Detection Systems (IDS) are developed to facilitate real-time monitoring of network and system activities. IDS employ sophisticated algorithms to analyse incoming data streams, detect patterns indicative of security threats or system malfunctions, and generate alerts when predefined conditions are met. Efficiency and accuracy of an IDS plays a critical role in mitigating potential threats and ensuring the seamless operation of enterprise infrastructures.

Traditionally, IDS utilize predefined alert parameters that are stored within an alert configuration file. This configuration file contains various parameters, such as severity levels, activation statuses, associated actions, and other metadata that govern how alerts are generated and managed. In order to enhance the speed and responsiveness of alert generation, IDS often leverage a cache memory to store a frequently accessed copy of the alert configuration file. By maintaining a cached version of the alert configuration file, the IDS can quickly retrieve relevant alert parameters without the need for repetitive queries to a main memory, thereby reducing latency and improving system performance.

However, a significant challenge arises when the alert configuration file is modified or updated recently. Updates to the alert configuration file may be necessitated by various factors, including changes in threshold values for triggering alerts, alterations in the network infrastructure, addition or removal of system components, or the refinement of security policies. In such scenarios, the cache memory may continue to retain an outdated version of the alert configuration file, causing the IDS to operate with obsolete parameters. As a result, the IDS may generate inaccurate or inappropriate alerts, leading to operational inefficiencies.

Such discrepancy between cached and updated versions of the alert configuration file can have severe consequences. For instance, it may lead to false positives, where unnecessary alerts are triggered, causing alarm fatigue among security personnel. Conversely, it can result in missed critical alerts, where genuine threats or system failures go undetected, exposing the enterprise to potential security breaches or operational disruptions. Additionally, improper alert generation due to outdated configuration data may hinder timely incident response, further compromising the reliability and effectiveness of the IDS.

Given the increasing complexity and dynamic nature of enterprise environments, there is a need for an improved approach to managing alert configuration files within IDS. An effective solution should ensure that modifications to the alert configuration file are promptly reflected in the cache memory, thereby preventing inconsistencies and enhancing the accuracy and reliability of alert generation.

### SUMMARY OF THE INVENTION

This summary is provided to introduce aspects related to a system and a method of alert management and the aspects are further described below in the detailed description. This summary is not intended to identify essential features of the claimed subject matter nor is it intended for use in determining or limiting the scope of the claimed subject matter.

In an embodiment of the present disclosure, a method of alert management is disclosed. The method includes a step of receiving data traffic related to a plurality of devices in an enterprise. Further, the method includes a step of analysing the data traffic to identify one or more anomalies associated with the data traffic.

For each anomaly, the method includes a step of identifying, in a cache memory, an alert configuration file associated with the anomaly. Furthermore, the method includes a step of retrieving, from a main memory, a change in status of the alert configuration file.

If the status of the alert configuration file is unchanged, the method includes a step of retrieving, from the cache memory, the alert configuration file. If the status of the alert configuration file is changed, the method includes a step of retrieving, from the main memory, an updated alert configuration file and replacing, in the cache memory, the alert configuration file with the updated alert configuration file. The method further includes a step of generating an alert using one of the alert configuration file and the updated alert configuration file.

In an aspect of the present disclosure, if the alert configuration file is not identified in the cache memory, the method includes a step of retrieving the alert configuration file from the main memory. Further, the method includes a step of storing the alert configuration file in the cache memory. Furthermore, the method includes a step of generating an alert using the alert configuration file.

In an aspect of the present disclosure, the alert configuration file comprises parameters including at least one of severity levels of alerts, activation statuses, and actions associated with alerts.

In an aspect of the present disclosure, an operating system component provides the change in the status of the alert configuration file.

In an aspect of the present disclosure, the step of retrieving the change in status of the alert configuration file is implemented using a decorator function.

In an aspect of the present disclosure, the cache memory uses a caching technique selected from a group consisting of least recently used, least frequently used, first-in-first-out, random replacement, and adaptive replacement caching.

In an aspect of the present disclosure, the cache memory includes at least one of L1 cache, L2 cache, L3 cache, L4 cache, and disk cache.

In an embodiment of the present disclosure, a system for alert management is disclosed. The system comprises a processor, a cache memory, and a main memory. The cache memory and the main memory are communicatively coupled with the processor. The main memory stores program instructions executable by the processor to receive data traffic related to a plurality of devices in an enterprise. Further, the main memory stores program instructions executable by the processor to analyse the data traffic to identify one or more anomalies associated with the data traffic.

For each anomaly, the main memory stores program instructions executable by the processor to identify, in the cache memory, an alert configuration file associated with the anomaly. The main memory stores program instructions executable by the processor to retrieve, from the main memory, a change in status of the alert configuration file.

If the status of the alert configuration file is unchanged, the main memory stores program instructions executable by the processor to retrieve, from the cache memory, the alert configuration file. If the status of the alert configuration file is changed, the main memory stores program instructions executable by the processor to retrieve, from the main memory, an updated alert configuration file and replace, in the cache memory, the alert configuration file with the updated alert configuration file. Further, the main memory stores program instructions executable by the processor to generate an alert using one of the alert configuration file and the updated alert configuration file.

In an aspect of the disclosure, if the alert configuration file is not identified in the cache memory, the main memory stores program instructions executable by the processor to retrieve the alert configuration file from the main memory. Further, the main memory stores program instructions executable by the processor to store the alert configuration file in the cache memory. Furthermore, the main memory stores program instructions executable by the processor to generate an alert using the alert configuration file.

In an aspect of the present disclosure, the alert configuration file includes parameters including at least one of severity levels of alerts, activation statuses, and actions associated with alerts.

In an aspect of the disclosure, an operating system component provides the change in the status of the alert configuration file.

In an aspect of the present disclosure, retrieving the change in status of the alert configuration file is implemented using a decorator function.

In an aspect of the present disclosure, the cache memory uses a caching technique selected from a group consisting of least recently used, least frequently used, first-in-first-out, random replacement, and adaptive replacement caching.

In an aspect of the disclosure, the cache memory includes at least one of L1 cache, L2 cache, L3 cache, L4 cache, and disk cache.

In an embodiment of the present disclosure, a non-transitory computer-readable storage medium comprising computer program code for execution by one or more processors of an apparatus, the computer program code configured to, when executed by the one or more processors, cause the apparatus to receive data traffic related to a plurality of devices in an enterprise. Further, the computer program code configured to analyse the data traffic to identify one or more anomalies associated with the data traffic.

For each anomaly, the computer program code configured to identify, in a cache memory, an alert configuration file associated with the anomaly. Further, the computer program code configured to retrieve, from a main memory, a change in status of the alert configuration file.

If the status of the alert configuration file is unchanged, the computer program code configured to retrieve, from the cache memory, the alert configuration file. If the status of the alert configuration file is changed, the computer program code configured to retrieve, from the main memory, an updated alert configuration file; and replace, in the cache memory, the alert configuration file with the updated alert configuration file. Furthermore, the computer program code configured to generate an alert using one of the alert configuration file and the updated alert configuration file.

In an aspect of the present disclosure, if the alert configuration file is not identified in the cache memory, the computer program code is configured to retrieve the alert configuration file from the main memory. Further, the computer program code configured to store the alert configuration file in the cache memory. Furthermore, the computer program code configured to generate an alert using the alert configuration file.

In an aspect of the present disclosure, the alert configuration file includes parameters including at least one of severity levels of alerts, activation statuses, and actions associated with alerts.

In an aspect of the present disclosure, an operating system component provides the change in the status of the alert configuration file.

In an aspect of the present disclosure, retrieving the change in status of the alert configuration file is implemented using a decorator function.

In an aspect of the present disclosure, the cache memory uses a caching technique selected from a group consisting of least recently used, least frequently used, first-in-first-out, random replacement, and adaptive replacement caching.

Other aspects and advantages of the invention will become apparent from the following description, taken in conjunction with the accompanying drawings, illustrating by way of example the principles of the invention.

### BRIEF DESCRIPTION OF THE DRAWINGS

The accompanying drawings constitute a part of the description and are used to provide a further understanding of the present disclosure. In the drawings:

FIG. 1 illustrates an architecture of a system for alert management, in accordance with an embodiment of the present disclosure;

FIG. 2 illustrates a block diagram of the system for alert management, in accordance with an embodiment of the present disclosure;

FIG. 3 illustrates a block diagram of the system comprising program instructions for alert management, in accordance with an embodiment of the present disclosure;

FIG. 4 illustrates a flow chart of a method of alert management, in accordance with an embodiment of the present disclosure;

FIG. 5 illustrates importing an alert configuration (AC) file into a cache memory, in accordance with an embodiment of the present disclosure;

FIG. 6 illustrates a flow chart of a method of retrieving a change in status of an AC file, in accordance with an embodiment of the present disclosure;

FIG. 7 illustrates updating an alert configuration file in the cache memory, in accordance with an embodiment of the present disclosure; and

FIGS. 8A and 8B cumulatively illustrate a flow chart of a method of alert management, in accordance with an embodiment of the present disclosure.

A more complete understanding of the present invention and its embodiments thereof may be acquired by referring to the following description and the accompanying drawings.

### DETAILED DESCRIPTION OF THE INVENTION

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

It is to be noted, however, that the reference numerals used herein illustrate only typical embodiments of the present subject matter, and are therefore, not to be considered for limiting its scope, for the subject matter may admit to other equally effective embodiments.

The detailed description includes specific details for the purpose of providing a thorough understanding of the present invention. However, it will be apparent to those skilled in the art that the present invention may be practiced without these specific details.

The present disclosure relates to a system and a method of alert management that improves the accuracy and efficiency of security and operational monitoring in enterprise environments. As enterprises generate large amounts of data traffic from various connected devices, it is essential to analyse the data traffic for anomalies that may indicate security threats or system issues. The disclosed system and method manage alert configuration files while ensuring that alerts are generated based on the most up-to-date parameters.

The system analyses data traffic, identifies anomalies, and retrieves the relevant alert configuration file from a cache memory for processing. The system determines whether the alert configuration file has been modified. If modified, update the cache memory with a latest version stored in a main memory. This prevents discrepancies between outdated and updated alert parameters, reducing false positives and missed alerts.

The present invention optimizes alert management by retrieving configuration files from cache memory whenever possible, reducing processing latency and improving performance. If an alert configuration file is not found in the cache, the system may retrieve it from the main memory and store the alert configuration file in the cache memory for future use. By implementing a caching mechanism, the system ensures timely and accurate alert generation, supporting enterprises in maintaining effective security monitoring and incident response.

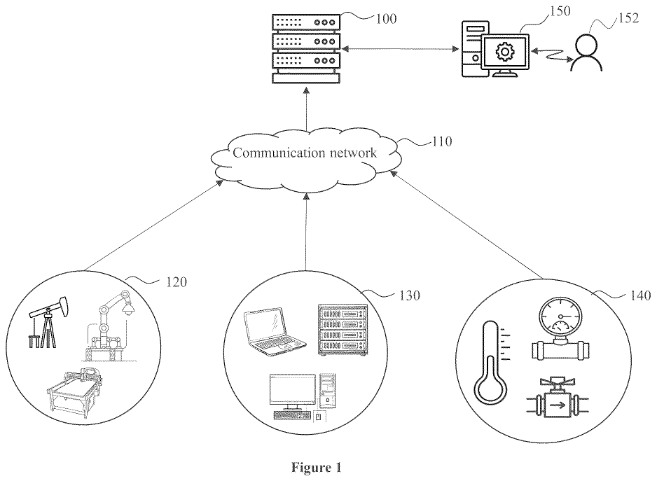

FIG. 1 illustrates an architecture of a system 100 for alert management. Enterprises including, but not limited to, a workstation 120, a computer setup 130, and an industrial plant 140 may provide a plurality of information to the system 100 for alert management. The workstation 120 may include one or more machines including computer numerical control (CNC) machines, telescopes, and digital microscopes. The computer setup 130 may include one or more devices/systems including laptops, servers, and desktops. The industrial plant 140 may include one or more devices including temperature sensors, pressure sensors, and control valves.

Such enterprises generate and process vast amounts of data, including system logs, network traffic, sensor readings, and other telemetry data. Therefore, such enterprises rely on automated monitoring services to ensure operational integrity, security, and compliance with regulatory standards. The continuous monitoring and analysis of such data are crucial for identifying anomalous events that may indicate security breaches, system failures, or other critical operational issues. The system 100 provides automated monitoring services to the workstation 120, the computer setup 130, and the industrial plant 140. In an embodiment, the system 100 may be an intrusion detection system. In one embodiment, the system 100 may be an alert generation system.

The system 100 may operate by mirroring data traffic received from such enterprises, via a communication network 110, allowing for real-time monitoring and analysis without directly integrating with machines/devices/systems and networks inside the workstation 120, the computer setup 130, and the industrial plant 140. The communication network 110 may utilize network components to establish connection among the system 100, and the workstation 120, the computer setup 130, and the industrial plant 140.

The network components may include, hubs, switches, routers, bridges, and repeaters. The routers may be of different types such as Provide Edge (PE) routers, Customer Edge (CE) routers, and intermediate routers. Further, the data traffic is the flow of digital information transmitted between one or more devices, systems, and networks within an enterprise. The data traffic may include, but is not limited to, network packets, system logs, and sensor data that provide insights into operational state of the enterprises.

The communication network 110 may be a wired and/or a wireless network. The communication network 110 may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art.

By mirroring the data traffic, the system 100 can analyse patterns, identify anomalies, and generate alerts without directly interacting with or modifying machines/devices/systems, and networks of the workstation 120, the computer setup 130, and the industrial plant 140. By employing a mirroring approach, the system 100 ensures that ongoing operations within the enterprises remain unaffected. Such an approach eliminates the risk of increased system overhead, performance degradation, or security vulnerabilities that might arise from direct integration. The system 100 continuously monitors mirrored data for anomalies, identifying potential security threats, system failures, or other critical operational events. Upon identifying an anomalous event, the system 100 is configured to generate an alert based on predefined detection criteria.

To identify the anomalous event, the system 100 may utilize data analysing techniques, including but not limited to, real-time anomaly detection algorithms, machine learning-based threat assessments, and pattern recognition models. Further, the system 100 includes one or more alert configuration files including configurable parameters, enabling one or more users 152 to customize alert thresholds, severity levels, and actions associated with an alert based on specific security and operational requirements of the workstation 120, the computer setup 130, and the industrial plant 140.

Upon detection of an anomalous event/anomaly in at least one of the workstation 120, the computer setup 130, and the industrial plant 140, the system 100 is configured to generate an alert based on an alert configuration file associated with the anomaly. The alert may be sent to the one or more users 152, via a user device 150. In an embodiment, the one or more users 152 may be at the workstation 120, the computer setup 130, and the industrial plant 140. In one embodiment, the one or more users 152 may be technicians responsible for handling the alert configuration files and the alerts generated by the system 100. Further, the user device 150 may include, but is not limited to, a computer, a laptop, a desktop, a and mobile phone.

In order to enhance speed and responsiveness of alert generation, the system 100 utilizes a cache memory to store frequently or recently accessed copies of the alert configuration files. By maintaining a cached version of the alert configuration file, the system 100 quickly retrieves relevant alert parameters without the need for repetitive queries to a main memory, thereby reducing latency and improving performance.

However, if an alert configuration file is changed recently, the cache memory may continue to retain an outdated version of the alert configuration file. As a result, inaccurate or inappropriate alerts may be generated, leading to operational inefficiencies. Changes to the alert configuration file may be necessitated by various factors, including but not limited to, changes in threshold values for triggering alerts, alterations in the network infrastructure, addition or removal of system components in an enterprise, or refinement of security policies.

The system 100 is configured to ensure that a most recently updated alert configuration file is used for generating an alert, by checking if the alert configuration file was recently changed, before fetching the alert configuration file from the cache memory. If the alert file is changed recently, the system 100 fetched an updated alert configuration file from the main memory and generates an alert using the updated alert configuration file.

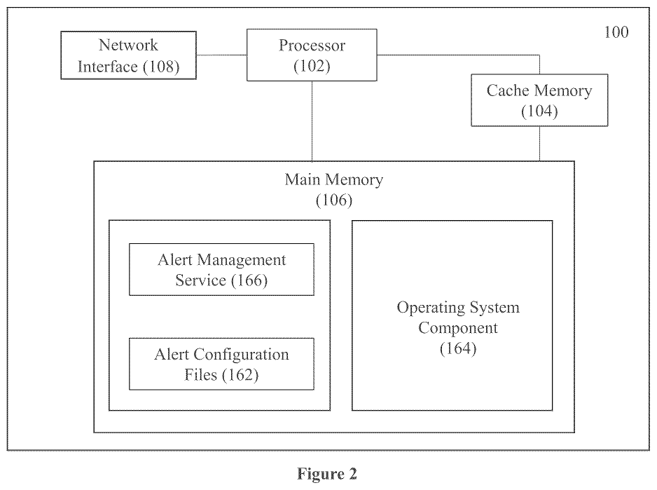

FIG. 2 illustrates a block diagram of the system 100 for alert management, in accordance with an embodiment of the present disclosure. The system 100 may be implemented remotely over a cloud network or locally. The system 100 may comprise one or more network interfaces (e.g., wired, wireless, etc.), at least one processor 102, a cache memory 104, and a main memory 106. The one or more network interfaces 108, the at least one processor 102, the cache memory 104, and the main memory 106 may be interconnected by a system bus, and a power supply. Further, the processor 102 is communicatively coupled with the cache memory 104, and the main memory 106.

The one or more network interfaces 108 may be used to provide input or fetch output from the system 100. The one or more network interfaces 108 may be implemented as a Command Line Interface (CLI) or a Graphical User Interface (GUI). Further, Application Programming Interfaces (APIs) may also be used for remotely interacting with edge systems and cloud servers.

The processor 102 may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

The cache memory 104 may include, but is not limited to, non-transitory machine-readable storage devices that provide high-speed data access and temporary storage for frequently or recently accessed data. The cache memory 104 may be implemented using semiconductor-based memory technologies such as Static Random-Access Memory (SRAM) and Dynamic Random-Access Memory (DRAM). Additionally, the cache memory 108 may include other high-speed memory technologies such as Non-Volatile RAM (NVRAM), Magneto-resistive RAM (MRAM), Phase-Change Memory (PCM), Resistive RAM (ReRAM), and embedded flash memory. The cache memory 104 may be configured to store recently retrieved alert configuration files, reducing a need to repeatedly access the main memory 106 and thereby improving performance and response time of the system 100.

The cache memory 104 employs a caching technique to optimize data retrieval and storage. The caching technique may be selected from a group consisting of Least Recently Used (LRU), Least Frequently Used (LFU), First-In-First-Out (FIFO), Random Replacement (RR), and Adaptive Replacement Caching (ARC). The LRU caching technique may ensure that a least recently accessed data is evicted from the cache memory 104, when new data needs to be stored, optimizing cache utilization based on temporal locality. The LFU caching technique removes data that has been accessed the least number of times, prioritizing frequently accessed data to remain in the cache for improved long-term efficiency.

The FIFO caching technique follows a queue-based approach where the oldest cached data is evicted first, making it simple and predictable but less adaptable to varying access patterns. The RR caching technique selects cache entries for eviction at random, reducing overhead but potentially leading to suboptimal caching decisions. The ARC technique adjusts between LRU and LFU strategies, optimizing cache performance based on access patterns while maintaining a balance between recent and frequent accesses. The selection of the caching technique may be based on system requirements, workload characteristics, and memory constraints, ensuring optimal performance and efficient resource utilization.

Further, structure of the cache memory 104 may include at least one of L1 cache, L2 cache, L3 cache, L4 cache, and disk cache, each serving a distinct role in enhancing processing efficiency. The L1 cache (Level 1 cache) is the fastest and closest to the processor cores, typically integrated within the processor, providing low-latency access to frequently used instructions and data. The L2 cache (Level 2 cache) acts as an intermediate buffer between the L1 cache and main memory, offering larger storage capacity with slightly higher latency but improving overall data retrieval performance. The L3 cache (Level 3 cache) is a larger and slower cache, shared among multiple processor cores, optimizing data access across cores and reducing memory bottlenecks in multi-core architectures.

The L4 cache (Level 4 cache), if present in the cache memory 104, provides an additional caching layer, either as an on-die or off-chip cache, further improving data access times and reducing main memory dependencies. The disk cache, also known as a page cache, stores frequently accessed disk data in volatile memory, significantly reducing disk read/write latency and enhancing overall system performance. The inclusion of multiple cache levels may minimize data access delays and improve efficiency of the system 100.

The main memory 106 may include, but is not limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

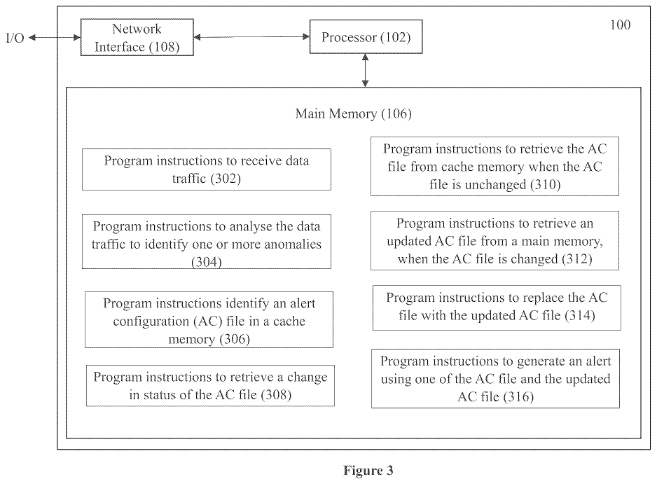

The memory 106 may include a plurality of storage locations that are addressable by the processor 102 and the network interfaces for storing software programs and other necessary information (alert configuration files 162, operating system component 164, and an alert management service 166) associated with the embodiments described herein. The alert management service 166 may cause the processor 102 to manage alerts by executing program instructions (shown in FIG. 3) stored in the main memory 106. The processor 102 may comprise hardware elements or hardware logic adapted to execute the software programs and manipulate data structures.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

The processor 102 of the system 100 is configured to receive data traffic related to a plurality of devices in an enterprise such as the workstation 120, the computer setup 130, and the industrial plant 140, as shown in the FIG. 1. Further, the processor 102 is configured to analyse the data traffic to identify one or more anomalies associated with the data traffic.

For each anomaly, the processor 102 is configured to identify an alert configuration file associated with the anomaly, in the cache memory. The system 100 includes one or more alert configuration files 162 in the main memory 106, that store parameters that define conditions for triggering alerts (activation statuses), the severity levels associated with different types of anomalies, and the corresponding actions to be taken upon detecting an anomalous event. The parameters may include, but are not limited to, threshold values for anomaly detection, time-based constraints for alert activation, escalation protocols, notification preferences, and response actions such as logging, automated remediation, or user notifications.

Further, the parameters in the alert configuration files 162 may be changed. Changes in the alert configuration files 162 may be made due to various factors, including changes in threshold values for triggering alerts, alterations in the network infrastructure of the enterprise, addition or removal of system components in the enterprise, or the refinement of security policies in the enterprise.

The cache memory may store copies of the alert configuration files 162 that are accessed frequently or recently. However, if an alert configuration file is changed recently, the cache memory 104 may continue to retain an outdated version of the alert configuration file. As a result, inaccurate or inappropriate alerts may be generated, leading to operational inefficiencies.

Upon identification of the alert configuration file associated with the anomaly. The processor 102 is configured to retrieve a change in status of the alert configuration file associated with the anomaly from the main memory 106. Retrieval of the change in status of the alert configuration file ensures that a most recently updated alert configuration file is used for generating an alert.

In an embodiment, the change in status of the alert configuration file is indicated by an operating system (OS) component 164 of the system 100. The main memory 106 may include the OS component 164. The OS component 164 is configured to monitor changes in the alert configuration files 162, ensuring that changes in the alert configuration files 162 are seamlessly incorporated without rebooting the system 100. As the OS component 164 monitors the alert configuration files 162, the system 100 improves processor utilization, as the processor 102 does not have to continuously monitor alert configuration files 162 for changes and can instead focus on executing other critical system functions.

The OS component 164 performs continuous checks to detect any changes in the alert configuration files 162. If a change in the alert configuration file associated with the anomaly is detected, the OS component 164 provides an indication to the alert management service 166, that a change in the status of the alert configuration file associated with the anomaly has occurred. The indication is then provided to the processor 102 allowing the processor 102 to recognize that an updated configuration file is available, in the main memory 106, without a need for direct monitoring of changes in the alert configuration files 162. As a result, the processor 102 is not burdened with continuous file status checks, thereby optimizing computational efficiency of the system 100. The processor 102 generates alerts based on one of the updated configuration file and the alert configuration file, only when it receives the indication from the OS component 164, via the alert management service 166, reducing processing overhead and enhancing system responsiveness.

Retrieving the change in status of the alert configuration file is implemented using a decorator function of the Python language. The decorator function is implemented as a wrapper around an existing alert configuration retrieval logic. A wrapper in the context of a Python decorator function refers to an additional layer of functionality that is added around an existing function without modifying core logic of the existing function.

The existing alert configuration retrieval logic may include directly retrieving an alert configuration file, if present in the cache memory 104, without checking for a change in the alert configuration files 162. In the case of the system 100, the decorator function ensures that every time an alert configuration file needs to be accessed, the system 100 must first check for changes in the alert configuration files 162 before proceeding with alert generation.

The decorator function operates by intercepting program instructions that access an alert configuration file. Each time a program instruction configures the processor 102 to read or retrieve an alert configuration file, the decorator function intercepts the program instruction and configures the processor 102 to check whether any changes have been made to the alert configuration file since it was last retrieved. In an embodiment, the checking is achieved by monitoring file metadata attributes of the alert configuration files 162, including but not limited to, timestamps, version identifiers, or hash values.

The OS component 164 works in conjunction with the decorator function by providing real-time indication of change in status of the alert configuration file. Combination of the OS component 164 and the decorator function enables real-time updates, reduces processing overhead, and ensures that the most accurate and recently updated alert configuration files are used for alert generation.

When the OS component 164 provides an indication that the alert configuration file associated with the anomaly has not been changed recently, the processor 102 retrieves the alert configuration file associated with the anomaly, from the cache memory 104. Further, the processor 102 may generate an alert using the alert configuration file.

When the OS component 164 provides an indication that the alert configuration file associated with the anomaly has been changed recently, the processor retrieves an updated alert configuration file, from the main memory. Further, the processor 102 replaces the alert configuration file in the cache memory 104 with the updated alert configuration file. Further, the processor 102 generates an alert using the updated alert configuration file.

In an embodiment of the present disclosure, if the alert configuration file is not identified in the cache memory 104, the processor 102 retrieves the alert configuration file associated with the anomaly, from the main memory 106. Further, the processor 102 stores the alert configuration file in the cache memory 104 for future use. The processor 102 then generates an alert using the alert configuration file.

FIG. 3 illustrates a block diagram of the system 100 comprising program instructions for alert management, in accordance with an embodiment of the present disclosure. Functional code stored in the main memory 106 may include program instructions to receive data traffic related to a plurality of devices in an enterprise 302, program instructions to analyse the data traffic to identify one or more anomalies associated with the data traffic 304. Further, for each anomaly, functional code stored in the main memory 106 may include program instructions to identify, in the cache memory 104, an alert configuration file associated with the anomaly 306, program instructions to retrieve, from the main memory 106, a change in status of the alert configuration file 308, program instructions to retrieve, from the cache memory 104, the alert configuration file, when the alert configuration file is unchanged 310, program instructions to retrieve, from the main memory 106, an updated alert configuration file, when the alert configuration file is changed 312, program instructions to replace, in the cache memory 104, the alert configuration file with the updated alert configuration file 314, and program instructions to generate an alert using one of the alert configuration file and the updated alert configuration file 316.

The program instructions to receive data traffic related to a plurality of devices in an enterprise 302, may cause the processor 102 to receive data traffic related to a plurality of devices in an enterprise. The enterprise may include, but not limited to, a workstation 120, a computer setup 130, and an industrial plant 140, as shown in FIG. 1. Further, the program instructions to analyse the data traffic to identify one or more anomalies associated with the data traffic 304, may the processor 102 to analyse the data traffic to identify one or more anomalies associated with the data traffic. The program instructions to identify, in the cache memory 104, an alert configuration file associated with the anomaly 306, may cause the processor 102 to identify, in the cache memory 104, an alert configuration file associated with the anomaly.

The program instructions to retrieve, from the main memory 106, a change in status of the alert configuration file 308, may cause the processor 102 to retrieve, from the main memory 106, a change in status of the alert configuration file. Retrieval of the change in status of the alert configuration file ensures that a most recently updated alert configuration file is used for generating an alert. In an embodiment, the change in status of the alert configuration file is indicated by the OS component 164 of the system 100.

The program instructions to retrieve, from the cache memory 104, the alert configuration file, when the alert configuration file is unchanged 310, may cause the processor 102 to retrieve, from the cache memory 104, the alert configuration file, when the alert configuration file is unchanged. The program instructions to retrieve, from the main memory 106, an updated alert configuration file, when the alert configuration file is changed 312, may cause the processor 102 to retrieve, from the main memory 106, an updated alert configuration file, when the alert configuration file is changed. The program instructions to replace, in the cache memory 104, the alert configuration file with the updated alert configuration file 314, may cause the processor 102 to replace, in the cache memory 104, the alert configuration file with the updated alert configuration file, and the program instructions to generate an alert using one of the alert configuration file and the updated alert configuration file 316, may cause the processor 102 to generate an alert using one of the alert configuration file and the updated alert configuration file.

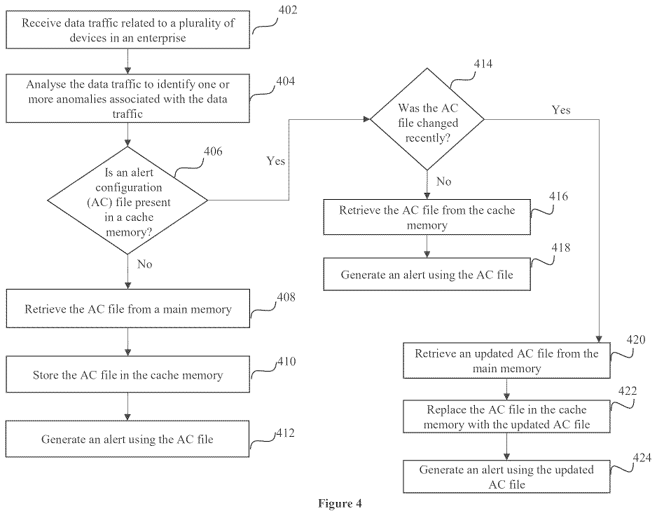

FIG. 4 illustrates a flow chart of a method of alert management, in accordance with an embodiment of the present invention. In this regard, each block may represent a module, segment, or portion of code, which comprises one or more executable instructions for implementing the specified logical function(s). It should also be noted that in some alternative implementations, the functions noted in the blocks may occur out of the order noted in the drawings.

For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The order in which method is described is not intended to be construed as a limitation, and any number of the described method blocks can be combined in any order to implement the method. Additionally, individual blocks may be deleted from the methods without departing from the scope of the subject matter described herein.

Furthermore, the method can be implemented in any suitable hardware, software, firmware, or combination thereof. Furthermore, the above-mentioned methods may be implemented in suitable hardware, computer-readable instructions, or a combination thereof. The steps of such methods may be performed by either a system under the instruction of machine-executable instructions stored on a non-transitory computer-readable medium or by dedicated hardware circuits, microcontrollers, or logic circuits. The method may include the following steps.

At step 402, data traffic related to a plurality of devices in an enterprise is received. The enterprise may generate and process vast amounts of data, including system logs, network traffic, sensor readings, and other telemetry data. Therefore, such enterprises rely on automated monitoring services to ensure operational integrity, security, and compliance with regulatory standards.

Further, the data traffic is the flow of digital information transmitted between one or more devices, systems, and networks within an enterprise. The data traffic may include but is not limited to, network packets, system logs, sensor data that provide insights into operational state of the enterprise.

At step 404, the data traffic is analysed to identify one or more anomalies associated with the data traffic. To identify the anomalous event, various data analyzing techniques may be utilised, including but not limited to, real-time anomaly detection algorithms, machine learning-based threat assessments, and pattern recognition models.

At step 406, for each anomaly, an alert configuration file associated with the anomaly is identified to be present in a cache memory, by an alert management service. An alert configuration file includes parameters, enabling a user to customize alert thresholds, severity levels, and actions associated with an alert based on specific security and operational requirements of the enterprise. The cache memory may be configured to store recently or frequently retrieved alert configuration files, reducing a need to repeatedly access a main memory.

The cache memory may employ a caching technique to optimize data retrieval and storage. The caching technique may be selected from a group consisting of Least Recently Used (LRU), Least Frequently Used (LFU), First-In-First-Out (FIFO), Random Replacement (RR), and Adaptive Replacement Caching (ARC). The LRU caching technique may ensure that a least recently accessed data is evicted from the cache memory, when new data needs to be stored, optimizing cache utilization based on temporal locality. The LFU caching technique removes data that has been accessed the least number of times, prioritizing frequently accessed data to remain in the cache for improved long-term efficiency.

The FIFO caching technique follows a queue-based approach where the oldest cached data is evicted first, making it simple and predictable but less adaptable to varying access patterns. The RR caching technique selects cache entries for eviction at random, reducing overhead but potentially leading to suboptimal caching decisions. The ARC technique adjusts between LRU and LFU strategies, optimizing cache performance based on access patterns while maintaining a balance between recent and frequent accesses. The selection of the caching technique may be based on system requirements, workload characteristics, and memory constraints, ensuring optimal performance and efficient resource utilization.

Further, structure of the cache memory may include at least one of L1 cache, L2 cache, L3 cache, L4 cache, and disk cache, each serving a distinct role in enhancing processing efficiency. The L1 cache (Level 1 cache) is the fastest and closest to the processor cores, typically integrated within the processor, providing low-latency access to frequently used instructions and data. The L2 cache (Level 2 cache) acts as an intermediate buffer between the L1 cache and main memory, offering larger storage capacity with slightly higher latency but improving overall data retrieval performance. The L3 cache (Level 3 cache) is a larger and slower cache, shared among multiple processor cores, optimizing data access across cores and reducing memory bottlenecks in multi-core architectures.

The L4 cache (Level 4 cache), if present in the cache memory, may provide an additional caching layer, either as an on-die or off-chip cache, further improving data access times and reducing main memory dependencies. The disk cache, also known as a page cache, stores frequently accessed disk data in volatile memory, significantly reducing disk read/write latency and enhancing overall system performance. The inclusion of multiple cache levels may minimize data access delays and improve efficiency of alert generation.

At step 408, if the alert configuration file associated with the anomaly is not identified to be present in the cache memory, the alert configuration file associated with the anomaly is retrieved from one or more alert configuration files stored in the main memory.

Further, at step 410, the alert configuration file associated with the anomaly is stored in the cache memory for future use.

At step 412, an alert may be generated using the alert configuration file associated with the anomaly.

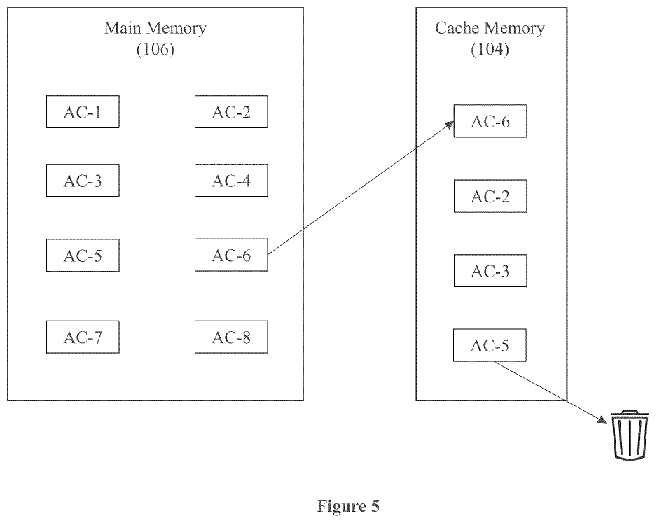

In an embodiment, step 408 and step 410 may be executed using a caching technique as shown in FIG. 5. The caching technique illustrated in the FIG. 5 is the LRU caching technique. The LRU caching technique ensures that a least recently accessed alert configuration file is evicted from the cache memory, when a new alert configuration needs to be stored in the cache memory, that was not initially stored in the cache memory. For example, as shown in the FIG. 5, AC-6 is the file required to generate an alert, and the file AC-6 is not identified to be present in the cache memory. The cache memory identifies a least recently used file (AC-5) and evicts the file AC-5, to store the AC-6 file in place of the file AC-5.

Now referring again to FIG. 4, at step 414, a change in status of the alert configuration file is retrieved from the main memory, if the alert configuration file is identified to be present in the cache memory. Retrieval of the change in status of the alert configuration file ensures that a most recently updated alert configuration file is used for generating an alert.

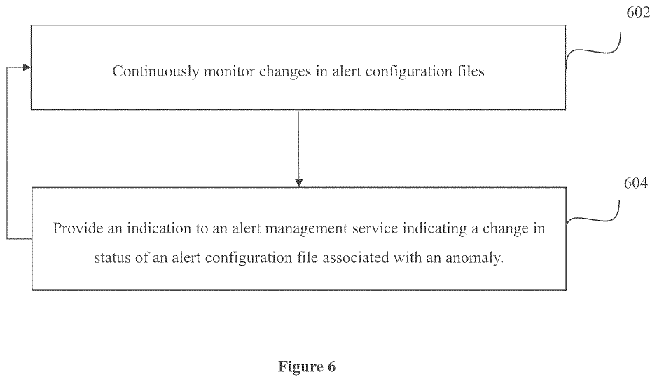

In an embodiment, the step 414 may be executed by an operating system component using steps prescribed in FIG. 6. At step 602, the one or more alert configuration files are continuously monitored for changes. Continuous monitoring ensures that changes in the one or more alert configuration files are seamlessly used for alert generation.

At step 604, an indication is provided, to the alert management service, that a change in the status of the alert configuration file associated with the anomaly has occurred or not. As a result, a system configured to manage alerts may not be burdened with continuous file status checks, thereby optimizing computational efficiency of the system.

Further, retrieving the change in status of the alert configuration file is implemented using a decorator function of the Python language. The decorator function is implemented as a wrapper around an existing alert configuration retrieval logic. A wrapper in the context of a Python decorator function refers to an additional layer of functionality that is added around an existing function without modifying core logic of the existing function.

The existing alert configuration retrieval logic may include directly retrieving an alert configuration file, if present in the cache memory, without checking for a change in the alert configuration files present in the main memory. The decorator function ensures that every time an alert configuration file needs to be accessed, the alert configuration files are checked for changes, before proceeding with alert generation.

The decorator function operates by intercepting program instructions that access an alert configuration file. Each time a program instruction configures the processor to read or retrieve an alert configuration file, the decorator function intercepts the program instruction and configures the processor to check whether any changes have been made to the alert configuration file since it was last retrieved. In an embodiment, the checking is achieved by monitoring file metadata attributes of the alert configuration files, including but not limited to, timestamps, version identifiers, or hash values.

The OS component works in conjunction with the decorator function by providing real-time indication of change in status of the alert configuration file. Combination of the OS component and the decorator function enables real-time updates, reduces processing overhead, and ensures that the most accurate and recently updated alert configuration files are used for alert generation.

Now again referring to FIG. 4, at step 416, the alert file associated with the anomaly is retrieved from the cache memory, if the status of the alert configuration file associated with the anomaly is indicated as unchanged.

Further, at step 418, an alert is generated using the alert configuration file associated with the anomaly.

At step 420, an updated alert configuration file is retrieved from the main memory, if the status of the alert configuration file associated with the anomaly is indicated as changed.

Further, at step 422, the alert configuration file is replaced with the updated alert configuration file present in the main memory. At step 424, an alert is generated using the updated alert configuration file.

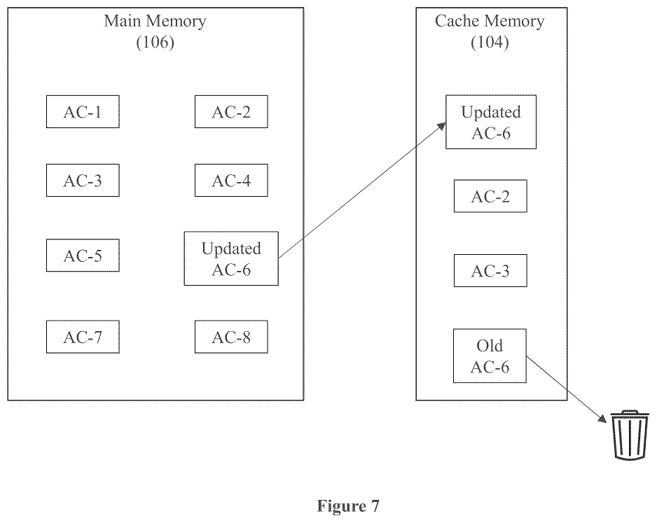

In an embodiment, the step 420 and the step 422 may be executed as shown in FIG. 7. For example, AC-6 (Old AC-6) is the alert configuration file required to generate an alert but, the file Old AC-6 is indicated as changed. Therefore, an Updated AC-6 from the main memory is stored in the cache memory in place of the Old AC-6. Further, the Old AC-6 is evicted from the cache memory.

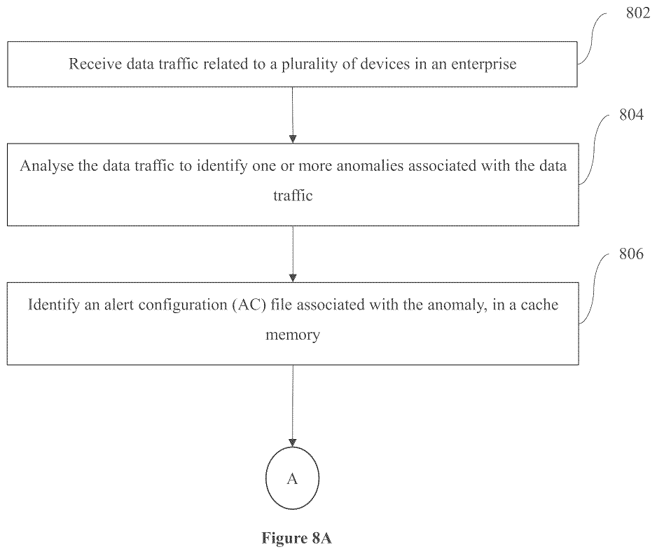

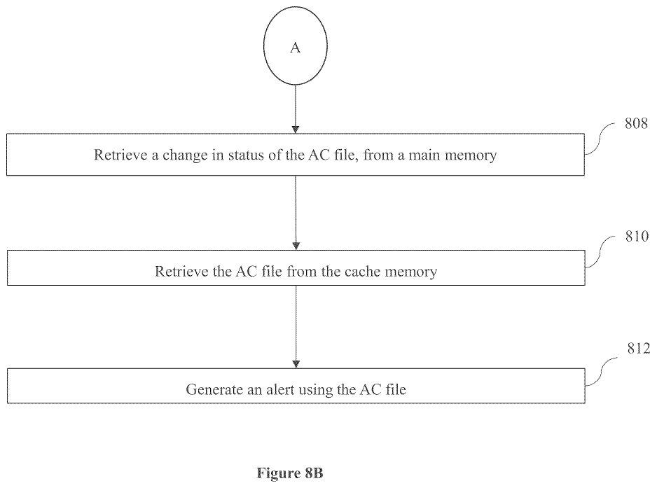

FIGS. 8A and 8B cumulatively illustrate a flow chart of a method of alert management, in accordance with an embodiment of the present invention. In this regard, each block may represent a module, segment, or portion of code, which comprises one or more executable instructions for implementing the specified logical function(s). It should also be noted that in some alternative implementations, the functions noted in the blocks may occur out of the order noted in the drawings.

For example, two blocks shown in succession in FIGS. 8A and 8B may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The order in which method is described is not intended to be construed as a limitation, and any number of the described method blocks can be combined in any order to implement the method. Additionally, individual blocks may be deleted from the methods without departing from the scope of the subject matter described herein.

Furthermore, the method can be implemented in any suitable hardware, software, firmware, or combination thereof. Furthermore, the above-mentioned methods may be implemented in suitable hardware, computer-readable instructions, or a combination thereof. The steps of such methods may be performed by either a system under the instruction of machine-executable instructions stored on a non-transitory computer-readable medium or by dedicated hardware circuits, microcontrollers, or logic circuits. The method may include the following steps.

At step 802, data traffic related to a plurality of devices in an enterprise is received. The enterprise may generate and process vast amounts of data, including system logs, network traffic, sensor readings, and other telemetry data. Therefore, such enterprises rely on automated monitoring services to ensure operational integrity, security, and compliance with regulatory standards.

Further, the data traffic is the flow of digital information transmitted between one or more devices, systems, and networks within an enterprise. The data traffic may include but is not limited to, network packets, system logs, sensor data that provide insights into operational state of the enterprise.

At step 804, the data traffic is analysed to identify one or more anomalies associated with the data traffic. To identify the anomalous event, various data analyzing techniques may be utilised, including but not limited to, real-time anomaly detection algorithms, machine learning-based threat assessments, and pattern recognition models.

At step 806, for each anomaly, an alert configuration file associated with the anomaly is identified to be present in a cache memory, by an alert management service. Alert configuration files include configurable parameters, enabling a user to customize alert thresholds, severity levels, and actions associated with an alert based on specific security and operational requirements of the enterprise. The cache memory may be configured to store recently retrieved alert configuration files, reducing a need to repeatedly access a main memory.

The cache memory may employ a caching technique to optimize data retrieval and storage. The caching technique may be selected from a group consisting of Least Recently Used (LRU), Least Frequently Used (LFU), First-In-First-Out (FIFO), Random Replacement (RR), and Adaptive Replacement Caching (ARC).

At step 808, a change in status of the alert configuration file is retrieved from the main memory, if the alert configuration file is identified to be present in the cache memory. Retrieval of the change in status of the alert configuration file ensures that a most recently updated alert configuration file is used for generating an alert.

In an embodiment, the step 808 may be executed by an operating system component using steps prescribed in the FIG. 6. At step 602, the alert configuration files are continuously monitored for changes. Continuous monitoring ensures that changes in the alert configuration files are seamlessly used for alert generation.

At step 604, an indication is provided, to the alert management service, that a change in the status of the alert configuration file associated with the anomaly has occurred or not. The indication allows the processor to recognize that an updated configuration file is available, in the main memory, without a need for direct monitoring of changes in the alert configuration files present in the main memory. As a result, a system configured to manage alerts is not burdened with continuous file status checks, thereby optimizing computational efficiency of the system.

Further, retrieving the change in status of the alert configuration file is implemented using a decorator function of the Python language. The decorator function is implemented as a wrapper around an existing alert configuration retrieval logic. A wrapper in the context of a Python decorator function refers to an additional layer of functionality that is added around an existing function without modifying core logic of the existing function.

The existing alert configuration retrieval logic may include directly retrieving an alert configuration file, if present in the cache memory, without checking for a change in the alert configuration files present in the main memory. The decorator function ensures that every time an alert configuration file needs to be accessed, the alert configuration files are checked for changes, before proceeding with alert generation.

The decorator function operates by intercepting program instructions that access an alert configuration file. Each time a program instruction configures the processor to read or retrieve an alert configuration file, the decorator function intercepts the program instruction and configures the processor to check whether any changes have been made to the alert configuration file since it was last retrieved. In an embodiment, the checking is achieved by monitoring file metadata attributes of the alert configuration files, including but not limited to, timestamps, version identifiers, or hash values.

The OS component works in conjunction with the decorator function by providing real-time indication of change in status of the alert configuration file. Combination of the OS component and the decorator function enables real-time updates, reduces processing overhead, and ensures that the most accurate and recently updated alert configuration files are used for alert generation.

Now referring to FIG. 8B, at step 810, the alert file associated with the anomaly is retrieved from the cache memory, if the status of the alert configuration file associated with the anomaly is indicated as unchanged.

Further, at step 812, an alert is generated using the alert configuration file associated with the anomaly.

### Technical Advancement and Economic Significance

The system and the method disclosed in the present invention of alert management may have the following advantages over conventional art:
Efficient alert processing is achieved by retrieving alert configuration files from cache memory, reducing latency in generating alerts.
Improved system reliability is ensured by employing a structured approach where an operating system component tracks changes in alert configuration files.
Accuracy of alerts are ensured by a decorator function, ensuring that any retrieval process first checks for changes in the status of a file before fetching the file.
Enhanced productivity is supported by reducing burden on IT support teams through automated retrieval, updating, and caching of alert configuration files.

The specification may refer to “an”, “another”, “one” or “some” embodiment(s) in several locations.

This does not necessarily imply that each such reference is to the same embodiment(s), or that the feature only applies to a single embodiment. Single features of different embodiments may also be combined to provide other embodiments.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skills in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Although implementations of a system and a method of alert management have been described in language specific to structural features and/or methods, it is to be understood that the appended claims are not necessarily limited to the specific features or methods described. Rather, the specific features and methods are disclosed as examples of implementations of a system and a method of alert management.

The invention has been described above with reference to numerous embodiments and specific examples. Many variations will suggest themselves to those skilled in this art in light of the above-detailed description. All such obvious variations are within the full intended scope of the appended claims.

We claim:

1. A method of alert management, comprising:
receiving data traffic related to a plurality of devices in an enterprise;
analysing the data traffic to identify one or more anomalies associated with the data traffic, and for each anomaly:
identifying, in a cache memory, an alert configuration file associated with the anomaly;
retrieving, from a main memory, a change in status of the alert configuration file, wherein
if the status of the alert configuration file is unchanged,
retrieving, from the cache memory, the alert configuration file;
if the status of the alert configuration file is changed,
retrieving, from the main memory, an updated alert configuration file; and
replacing, in the cache memory, the alert configuration file with the updated alert configuration file; and
generating an alert using one of the alert configuration file and the updated alert configuration file.

2. The method as claimed in claim 1, wherein if the alert configuration file is not identified in the cache memory,
retrieving the alert configuration file from the main memory;
storing the alert configuration file in the cache memory; and
generating an alert using the alert configuration file.

3. The method as claimed in claim 1, wherein the alert configuration file comprises parameters including at least one of severity levels of alerts, activation statuses, and actions associated with alerts.

4. The method as claimed in claim 1, wherein an operating system component provides the change in the status of the alert configuration file.

5. The method as claimed in claim 1, wherein retrieving the change in status of the alert configuration file is implemented using a decorator function.

6. The method as claimed in claim 1, wherein the cache memory uses a caching technique selected from a group consisting of least recently used, least frequently used, first-in-first-out, random replacement, and adaptive replacement caching.

7. The method as claimed in claim 1, wherein the cache memory includes at least one of L1 cache, L2 cache, L3 cache, L4 cache, and disk cache.

8. A system for alert management, comprises:
a processor;
a cache memory; and
a main memory, wherein the cache memory and the main memory are communicatively coupled with the processor, and the main memory stores program instructions executable by the processor to:
receive data traffic related to a plurality of devices in an enterprise;
analyse the data traffic to identify one or more anomalies associated with the data traffic, and for each anomaly:
identify, in the cache memory, an alert configuration file associated with the anomaly;
retrieve, from the main memory, a change in status of the alert configuration file, wherein
if the status of the alert configuration file is unchanged,
retrieve, from the cache memory, the alert configuration file;
if the status of the alert configuration file is changed,
retrieve, from the main memory, an updated alert configuration file; and
replace, in the cache memory, the alert configuration file with the updated alert configuration file; and
generate an alert using one of the alert configuration file and the updated alert configuration file.

9. The system as claimed in claim 8, wherein if the alert configuration file is not identified in the cache memory, the main memory stores program instructions executable by the processor to:
retrieve the alert configuration file from the main memory;
store the alert configuration file in the cache memory; and
generate an alert using the alert configuration file.

10. The system as claimed in claim 8, wherein the alert configuration file includes parameters including at least one of severity levels of alerts, activation statuses, and actions associated with alerts.

11. The system as claimed in claim 8, wherein an operating system component provides the change in the status of the alert configuration file.

12. The system as claimed in claim 8, wherein retrieving the change in status of the alert configuration file is implemented using a decorator function.

13. The system as claimed in claim 8, wherein the cache memory uses a caching technique selected from a group consisting of least recently used, least frequently used, first-in-first-out, random replacement, and adaptive replacement caching.

14. The system as claimed in claim 8, wherein the cache memory includes at least one of L1 cache, L2 cache, L3 cache, L4 cache, and disk cache.

15. A non-transitory computer-readable storage medium comprising computer program code for execution by one or more processors of an apparatus, the computer program code configured to, when executed by the one or more processors, cause the apparatus to:
receive data traffic related to a plurality of devices in an enterprise;
analyse the data traffic to identify one or more anomalies associated with the data traffic, and for each anomaly:
identify, in a cache memory, an alert configuration file associated with the anomaly;
retrieve, from a main memory, a change in status of the alert configuration file, wherein
if the status of the alert configuration file is unchanged,
retrieve, from the cache memory, the alert configuration file;
if the status of the alert configuration file is changed,
retrieve, from the main memory, an updated alert configuration file; and
replace, in the cache memory, the alert configuration file with the updated alert configuration file; and
generate an alert using one of the alert configuration file and the updated alert configuration file.

16. The non-transitory computer-readable storage medium as claimed in claim 15, wherein if the alert configuration file is not identified in the cache memory, the computer program code configured to, when executed by the one or more processors, cause the apparatus to:
retrieve the alert configuration file from the main memory;
store the alert configuration file in the cache memory; and
generate an alert using the alert configuration file.

17. The non-transitory computer-readable storage medium as claimed in claim 15, wherein the alert configuration file includes parameters including at least one of severity levels of alerts, activation statuses, and actions associated with alerts.

18. The non-transitory computer-readable storage medium as claimed in claim 15, an operating system component provides the change in the status of the alert configuration file.

19. The non-transitory computer-readable storage medium as claimed in claim 15, wherein retrieving the change in status of the alert configuration file is implemented using a decorator function.

20. The non-transitory computer-readable storage medium as claimed in claim 15, wherein the cache memory uses a caching technique selected from a group consisting of least recently used, least frequently used, first-in-first-out, random replacement, and adaptive replacement caching.
